(19) United States
(12) Patent Application Publication
(10) Pub. No.: US 2009/0216844 A1
(43) Pub. Date: Aug. 27, 2009

(54) Systems And Methods For Instant Communication In A Clinical Setting

(75) Inventors: Kaushik Patel, Des Plaines, IL (US); David Czarnecki, Clifton Park (NY); Arpita Patadia, Crystal Lake, IL (US); Christine Peeters, Bartlett, IL (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 12/038,336

(22) Filed: Feb. 27, 2008

(51) Int. Cl. G06F 15/16

(52) U.S. Cl. 709/206

(57) ABSTRACT

Embodiments of the present technology provide a system and method for instant communication in a clinical setting. The system includes a database wherein the database contains clinical data points; at least one bot wherein the bot receives a query and returns a result from the clinical data points; at least two workstations having a clinical instant messaging interface wherein the clinical instant messaging interface displays users that are using the clinical instant messaging interface, allows one of the users to input a message to other users and displays messages from the other users; and a clinical instant messaging network wherein the clinical instant messaging network accommodates messaging between the workstations and also between the workstations and the bots.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Generally, the technical field involves systems and methods for instant communication in a clinical setting.

In a fast-paced, clinical setting communication between employees is extremely important. Quick and accurate communication can literally be a matter of life and death. Information regarding a patient's care and condition needs to be transmitted quickly and effectively to various individuals.

A caregiver may also need access to information that he or she does not know off of the top of their head. For example, a caregiver may need to know about a drug, a medical definition or an abbreviation. Using search engines such as “Google” or “Yahoo” to find such information can be time consuming because it tends to overload the user with information.

A caregiver may also have a question for a certain type of individual but not a specific individual within the clinical setting. For example, a nurse may have a question about medication that could be answered by any of the pharmacists in the clinical setting. It would be efficient for the nurse to be able to communicate quickly with any of the pharmacists rather than any one individual.

### BRIEF SUMMARY OF THE INVENTION

Certain embodiments of the present technology provide systems and methods for instant communication in a clinical setting.

Certain embodiments of the present system for instant communication in a clinical setting include a database wherein the database contains clinical data points; at least one bot wherein the bot receives a query and returns a result from the clinical data points; at least two workstations having a clinical instant messaging interface wherein the clinical instant messaging interface displays users that are using the clinical instant messaging interface, allows one of the users to input a message to other users and displays messages from the other users; and a clinical instant messaging network wherein the clinical instant messaging network accommodates messaging between the workstations and also between the workstations and the bots.

Certain embodiments of the present method for instant communication in a clinical setting include compiling a database containing clinical data points; connecting users to a clinical instant messaging network; displaying users that are using the clinical instant messaging network; displaying bots available on the clinical instant messaging network; obtaining a message from one of the users to another of the users or to one of the bots; transmitting the message; and transmitting a response message to the first user from another user or from one of the bots.

Certain embodiments of the present computer-readable medium having a set of instructions for execution by a computer include a compilation routine configured to compile a database containing clinical data points; a connection routine configured to connect users to a clinical instant messaging network; a display routine configured to display users that are using the clinical instant messaging network; a second display routine configured to display bots available on the clinical instant messaging network; a messaging routine configured to obtain a message from one of the users to another of the users or to one of the bots; a transmission routine configured to transmit the message; and a response routine configured to transmit a response message to the first user from another user or from one of the bots.

These and other features of the present invention are discussed or apparent in the following detailed description.

### BRIEF DESCRIPTION OF SEVERAL VIEWS OF THE DRAWINGS

FIG. 1 illustrates a system for instant communication in a clinical setting according to an embodiment of the present technology.

FIG. 2 illustrates a flow diagram for a method of instant communication in a clinical setting according to an embodiment of the present technology.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

The current technology relates to systems and methods for instant communication in a clinical setting. Although certain particulars are used as examples, the current technology should not be viewed as limited to such systems.

The current disclosure relates to a clinical instant messaging system and method. The clinical instant messaging system and method allows a user to chat with other logged on users. It also allows a user to ask questions of bots. The user can enter a question for the bot in the same manner he or she would if chatting with another individual. The bot can then respond back with the information the user is seeking. The system would also have a function allowing the user to send messages according to role, thus allowing a user to quickly speak to a person having the information he or she is seeking.

The clinical instant messaging system and method would make it easier to communicate with logged on users, nurses, physicians, etc. It would also allow caregivers to quickly obtain medical information without wading through unrelated information on a generic search engine such as “Google” or “Yahoo.”

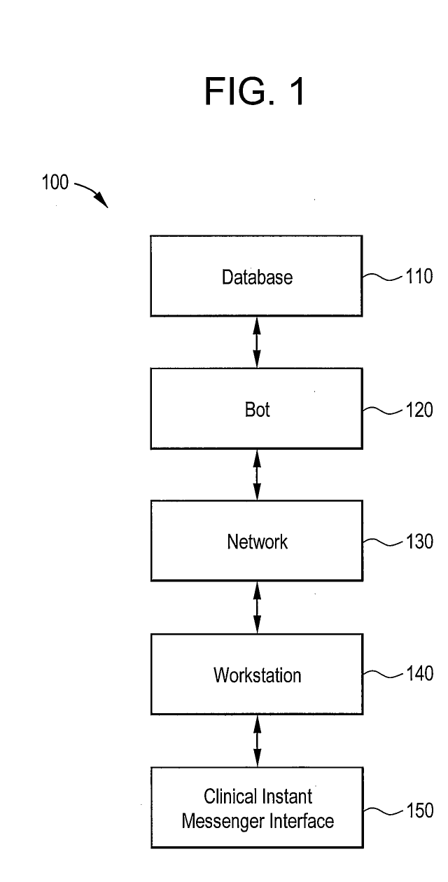

FIG. 1 illustrates a system (100) for instant communication in a clinical setting according to an embodiment of the present technology. In one embodiment, the present system (100) comprises a database (110) wherein the database (110) contains clinical data points; at least one bot (120) wherein the bot (120) receives a query and returns a result from the clinical data points; at least two workstations (140) having a clinical instant messaging interface (150) wherein the clinical instant messaging interface (150) displays users that are using the clinical instant messaging interface (150), allows one of the users to input a message to other users and displays messages from the other users; and a clinical instant messaging network (130) wherein the clinical instant messaging network (130) accommodates messaging between the workstations (140) and also between the workstations (140) and the bot (120).

The database (110) is in communication with the at least one bot (120), and vice versa. The at least one bot (120) is in communication with the clinical instant messaging network (130), and vice versa. The clinical instant messaging network (130) is also in communication with the workstations (140), and vice versa.

The components of the system (100) may be implemented alone or in combination with hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. The system may be integrated in various forms and/or may be provided as software and/or other functionality on a computing device, such as a computer. Certain embodiments may omit one or more of the components of the system (100).

The current system (100) is comprised of a database (110). The database (110) contains clinical data points. In one embodiment, the clinical data points could be medical definitions. In another, the clinical data points could be medical abbreviations and their meanings. In yet another embodiment, the clinical data points could deal with drug information. Drug information could include primary drug name, secondary drug name, generic drug name, scan identification number, National Drug Code (NDC) number, image, and quantity available in the pharmacy.

The clinical data points in the database can then be accessed by the at least one bot (120). The bot (120) receives a query and returns a result from the clinical data points. The bot interfaces with a user. The bot obtains a query from the user. This can be done using a bot interface, which can be a part of the clinical instant messaging interface described in detail below. The bot can then import clinical data points from the database (110). The bot can then search the imported clinical data points for clinical data points associated with the query. The bot can then export those clinical data points associated with the query to the bot interface for the user to access the information.

The user can message the bot with keywords and the bot responds with keyword details. For example, the bot could be an abbreviation bot. When the user inputs an abbreviation, the bot can return its meaning. As another example, the bot could be a medical dictionary bot. When the user inputs a medical term, the bot could return its definition. As yet another example, the bot could be a pharmaceutical bot. When the user inputs a drug name, the bot could return information about the drug including, but not limited to, primary drug name, secondary drug name, generic drug name, scan identification number, National Drug Code (NDC) number, image, and quantity available in the pharmacy.

The bot would appear on the clinical instant messaging system (100) like any other user. The bot would be online at anytime the user is logged on. The user could then send a message to bot like any other user. The bot would respond using the appropriate clinical data points from the database. A system could have one bot or multiple bots.

The current system further comprises at least two workstations (140). The users would each use a workstation (140). Examples of types of workstations (140) include, but are not limited to, desktops, laptops or handheld computing devices that are connected over a network to the healthcare information system, or home computers using specialized software from the hospital, for example.

The workstations have a clinical instant messaging interface (150). The user interacts with the clinical instant messaging interface (150). The clinical instant messaging interface (150) displays users that are using the clinical instant messaging interface (150). This could be done in the form of an icon for each user that is logged on. The icon could include the user's name, position, etc. A separate icon for user's that are not logged on could also be provided. The bots (120) would also have icons similar to that of logged on users. The bots (120) would be logged on whenever a user is using the clinical instant messaging interface (150).

The clinical messaging interface (150) also allows a user to input a message to other users. The user could input his or her messages using an input device. Examples of input devices include, but are not limited to, keyboards, touchscreens, joysticks, mice, touchpads, and microphones.

The clinical messaging interface (150) also displays incoming messages from the other users and/or the bots. Messages from other users and/or the bots can be displayed using the clinical messaging interface (150). This can be done using text, icons or a combination of text and icons on the computer screen. This could additionally be done using workstation speakers to add an audible element to the clinical instant messaging system.

The current system further comprises a clinical instant messaging network (130). The clinical instant messaging network (130) accommodates messaging between the workstations (140) and also between the workstations (140) and the bots (120). After the message is inputted by one user into his or her workstation, it is transmitted to the recipient user and appears on his or her workstation. This is done via the clinical instant messaging network (130).

In one embodiment of the current system, each of the users is associated with a role. A user can enter a message for any user of a certain role and the message will go to all users of that role. There could be a special icon for users of a certain role. For example, a user could have a question for a nurse. The user could choose the appropriate icon to send a message to all nurses that are logged onto the network. The user would not need to choose individual nurses. Examples of possible roles include, but are not limited to, physicians, nurses, pharmacists, emergency medical technicians, paramedics, and administrative staff.

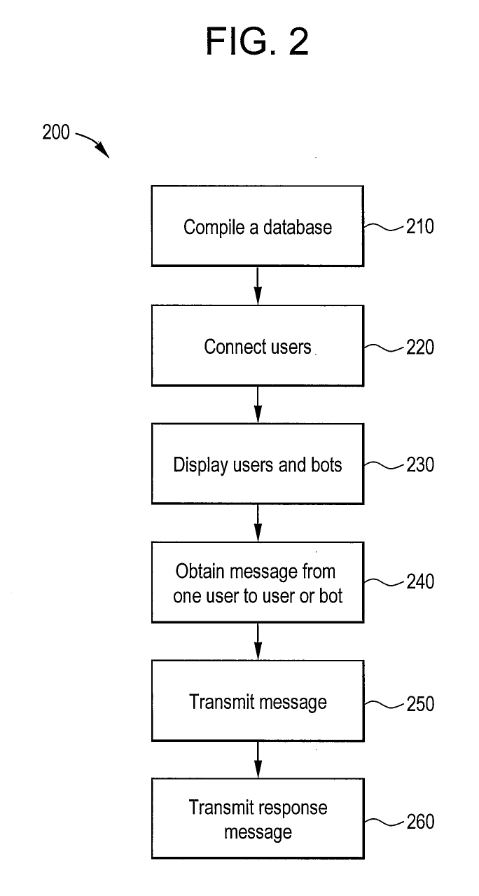

FIG. 2 illustrates a method (200) of instant communication in a clinical setting according to an embodiment of the present technology. The method (200) involves compiling a database containing clinical data points (210); connecting users to a clinical instant messaging network (220); displaying users that are using the clinical instant messaging network (230); displaying bots available on the clinical instant messaging network (230); obtaining a message from one of the users to another of the users or to one of the bots (240); transmitting the message (250); and transmitting a response message to the first user from the recipient user or from the recipient bot (260).

In the first step a database containing clinical data points is compiled (210). The database may take the form of the database, such as (110) discussed above. The database contains clinical data points. In one embodiment, the clinical data points could be medical definitions. In another, the clinical data points could be medical abbreviations and their meanings. In yet another embodiment, the clinical data points could deal with drug information. Drug information could include primary drug name, secondary drug name, generic drug name, scan identification number, National Drug Code (NDC) number, image, and quantity available in the pharmacy.

In the next step users are connected to a clinical instant messaging network (220). The clinical instant messaging may take the form of a clinical instant messaging network, such as (130) discussed above. The user may connect using a workstation, such as (140) described above. The users' workstations could be desktops, laptops or handheld computing devices that are connected over a network to the healthcare information system, or home computers using specialized software from the hospital, for example.

The clinical instant messaging network accommodates messaging between the workstations and also between the workstations and the bots. After the message is inputted by one user into his or her workstation, it is transmitted to the recipient user and appears on his or her workstation. This is done via the clinical instant messaging network.

In the next step users that are using the clinical instant messaging network and bots available on the clinical instant messaging network are displayed (230). The users and bots can be displayed using a clinical instant messaging interface, such as (150) described above. The bots can be bots, such as (120) described above. The bots receive queries and return results from the clinical data points. The bot interfaces with a user. The bot obtains a query from the user. This can be done using a bot interface, which can be a part of the clinical instant messaging interface described in detail below. The bot can then import clinical data points from the database (110). The bot can then search the imported clinical data points for clinical data points associated with the query. The bot can then export those clinical data points associated with the query to the bot interface for the user to access the information.

The user can message the bot with keywords and the bot responds with keyword details. For example, the bot could be an abbreviation bot. When the user inputs an abbreviation, the bot can return its meaning. As another example, the bot could be a medical dictionary bot. When the user inputs a medical term, the bot could return its definition. As yet another example, the bot could be a pharmaceutical bot. When the user inputs a drug name, the bot could return information about the drug including, but not limited to, primary drug name, secondary drug name, generic drug name, scan identification number, National Drug Code (NDC) number, image, and quantity available in the pharmacy. A system could have one bot or multiple bots.

The clinical instant messaging interface displays users that are using the clinical instant messaging interface. This could be done in the form of an icon for each user that is logged on. The icon could include the user's name, position, etc. A separate icon for user's that are not logged on could also be provided. The bots would also have icons similar to that of logged on users. The bots would be logged on whenever a user is using the clinical instant messaging interface (150). The user could then send a message to bot like any other user. The bot would respond using the appropriate clinical data points from the database.

In the next step a message is obtained from one of the users to another of the users or to one of the bots (240). The message can be obtained using a clinical instant messaging interface, such as (150) described above. The clinical messaging interface also allows a user to input a message to other users. The user could input his or her messages using an input device. Examples of input devices include, but are not limited to, keyboards, touchscreens, joysticks, mice, touchpads, and microphones.

In the next step the message is transmitted to one of the other users or to one of the bots (250). The clinical instant messaging network accommodates messaging between the workstations and also between the workstations and the bots. After the message is inputted by one user into his or her workstation, it is transmitted to the recipient user and appears on his or her workstation. This is done via the clinical instant messaging network.

In the next step a response message is transmitted to the first user from the recipient user or from the recipient bot (260). Messages from other users and/or the bots can be displayed using the clinical messaging interface. This can be done using text, icons or a combination of text and icons on the computer screen. This could additionally be done using workstation speakers to add an audible element to the clinical instant messaging system.

In one embodiment of the current method, each of the users is associated with a role. A user can enter a message for any user of a certain role and the message will go to all users of that role. There could be a special icon for users of a certain role. For example, a user could have a question for a pharmacist. The user could choose the appropriate icon to send a message to all pharmacists that are logged onto the network. The user would not need to choose individual pharmacists. Examples of possible roles include, but are not limited to, physicians, nurses, pharmacists, emergency medical technicians, paramedics, and administrative staff.

One or more of the steps of the methods (200) may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments may be implemented in one or more of the systems described above. For example, certain embodiments of the method (200) may be implemented using one or more local EMR (electronic medical record) systems, a database or other data storage storing electronic data, and one or more user interfaces facilitating capturing, integrating and/or analyzing information inputted by the patient.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

In one example, a user logs onto the clinical instant messaging network on his laptop. Once logged on he sees the clinical instant messaging interface. The interface has icons for all logged on users. The logged on users are sorted by role. The interface also has an icon for an abbreviation bot, a medical dictionary bot and a pharmacy bot. The user clicks on the pharmacy bot using his mouse. A dialogue box then appears. He enters his message into the dialogue box using his keyboard. His message contains the generic name of a drug. A response dialogue box then appears containing the primary drug name, secondary drug name, scan identification number, National Drug Code (NDC) number, image, and quantity available in the pharmacy.

In another example, a user logs onto the clinical instant messaging network on her hand-held computing device. Once logged on she sees the clinical instant messaging interface. The interface has icons for all logged on users. The logged on users are sorted by role. The interface also has an icon for an abbreviation bot, a medical dictionary bot and a pharmacy bot. The user clicks on a certain user's icon. A dialogue box then appears. She enters her message into the dialogue box using a microphone. Her message is sent to the user whose icon she selected. The recipient user can then respond to her message and the response will appear on her hand-held computing device.

In yet another example, a user logs onto the clinical instant messaging network on a desktop computer in the clinical environment. Once logged on she sees the clinical instant messaging interface. The interface has icons for all logged on users. The logged on users are sorted by role. The interface also has an icon for an abbreviation bot, a medical dictionary bot and a pharmacy bot. The user clicks on the icon for physicians. A dialogue box then appears. She enters her message into the dialogue box using a keyboard. Her message is sent to all logged on physicians. Any one of the physicians who receives the message can then respond to her message. The roles offer the added advantage of speeding up response time.

Thus, certain embodiments provide the technical effect of instant communication in a clinical setting.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of any clinical software feedback and dynamic scheduling/planning system. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

1. A system for instant communication in a clinical setting comprising:
a database wherein said database contains clinical data points;
at least one bot wherein said bot receives a query and returns a result from said clinical data points;
at least two workstations having a clinical instant messaging interface wherein said clinical instant messaging interface displays users that are using said clinical instant messaging interface, allows one of said users to input a message to other users and displays messages from said other users; and
a clinical instant messaging network wherein said clinical instant messaging network accommodates messaging between said workstations and also between said workstations and said bots.

2. The system of claim 1 wherein each of said users is associated with a role.

3. The system of claim 2 wherein one of said users can enter a message for any user of a certain role and said message will go to all users of said role.

4. The system of claim 1 wherein said query is a medical term and said result is a meaning of said medical term.

5. The system of claim 1 wherein said query is an abbreviation and said result is a meaning of said abbreviation.

6. The system of claim 1 wherein said query is a drug name and said result is detailed information about said drug.

7. The system of claim 1 wherein said query is a keyword and said result is keyword details.

8. A method of instant communication in a clinical setting comprising:
compiling a database containing clinical data points;
connecting users to a clinical instant messaging network;
displaying users that are using said clinical instant messaging network;
displaying bots available on said clinical instant messaging network;
obtaining a message from one of said users to another of said users or to one of said bots;
transmitting said message; and
transmitting a response message to said one of said users from another of said users or from one of said bots.

9. The method of claim 8 wherein the steps are performed sequentially.

10. The method of claim 8 wherein each of said users is associated with a role.

11. The method of claim 8 wherein one of said users can enter a message for any user of a certain role and said message will go to all users of said role.

12. The method of claim 8 wherein one of said bots receives a message regarding a medical term and responds with a meaning of said medical term.

13. The method of claim 8 wherein one of said bots receives a message regarding an abbreviation and responds with a meaning of said abbreviation.

14. The method of claim 8 wherein one of said bots receives a message regarding a drug name and responds with detailed information about said drug.

15. The method of claim 8 wherein one of said bots receives a message regarding a keyword and responds with keyword details.

16. A computer-readable medium having a set of instructions for execution by a computer, the set of instruction comprising:
a compilation routine configured to compile a database containing clinical data points;
a connection routine configured to connect users to a clinical instant messaging network;
a display routine configured to display users that are using said clinical instant messaging network;
a second display routine configured to display bots available on said clinical instant messaging network;
a messaging routine configured to obtain a message from one of said users to another of said users or to one of said bots;
a transmission routine configured to transmit said message; and
a response routine configured to transmit a response message to said one of said users from another of said users or from one of said bots.

17. The computer-readable medium of claim 16 wherein each of said users is associated with a role.

18. The computer-readable medium of claim 16 wherein one of said users can enter a message for any user of a certain role and said message will go to all users of said role.

19. The computer-readable medium of claim 16 wherein at least one of said bots receives a message regarding a keyword and responds with keyword details.

20. The computer-readable medium of claim 16 wherein at least one of said bots receives a message regarding a medical term and responds with a meaning of said medical term.
